(19) United States
(12) Patent Application Publication
(10) Pub. No.: US 2012/0119942 A1
(43) Pub. Date: May 17, 2012

(54) RADAR WAVE TRANSMIT/RECEIVE DEVICE

(75) Inventors: Laurence Moquillon, Lumbin (FR); Patrice Garcia, Crolles (FR)

(73) Assignee: STMicroelectronics S.A., Montrouge (FR)

(21) Appl. No.: 13/243,693

(22) Filed: Sep. 23, 2011

(30) Foreign Application Priority Data
Nov. 12, 2010 (FR) 10/59319

(51) Int. Cl. G01S 13/34

(52) U.S. Cl. 342/200

(57) ABSTRACT

Device for transmitting/receiving frequency modulated type radar waves that includes: a circuit for generating radar waves which includes a voltage-controlled oscillator coupled to a circulator which is itself connected to a transmit/receive antenna; a detection circuit including a first mixer which is fed by the circulator and the voltage-controlled oscillator, wherein voltage-controlled oscillator incluing an input for injecting a signal generated by an additional circuit, the additional circuit having its input fed by the output signal of voltage-controlled oscillator and including a second mixer which is fed by two signals generated on the basis of the output signal of voltage-controlled oscillator.

### CROSS REFERENCE TO RELATED APPLICATIONS

This application is a translation of and claims the priority benefit of French patent application number 10/59319, filed on Nov. 12, 2010, entitled “Device for emitting and receiving radar waves” which is hereby incorporated by reference to the maximum extent allowable by law.

### BACKGROUND OF THE INVENTION

1. Field of the Invention

The present invention relates to a device for transmitting frequency-modulated radar waves, especially Frequency Modulated Continuous Wave (FMCW) radar systems.

It relates more particularly to layouts that make it possible to reduce the low-frequency noise that is present in the received signal and which is caused by leakage and reflection.

2. Discussion of the Related Art

Classically, a radar wave transmit/receive device combines a generating and transmitter circuit with a circuit for detecting radar waves that are reflected by detected obstacles.

More precisely, a circuit for generating monostatic radar waves conventionally comprises a Voltage Controlled Oscillator (VCO) which is coupled to a circulator which is itself connected to a transmit/receive antenna. Controlling the VCO appropriately makes it possible to generate the desired waveforms in the desired frequency range.

After being transmitted by the antenna, any waves reflected by possible obstacles can also be detected by this same antenna. These reflected waves have frequency characteristics that depend both on the range and the relative velocity of the obstacles.

The detection circuit that makes it possible to produce the desired signal comprises a circulator which is connected to the antenna and thus outputs the received signal to a mixer whereof another input is connected to the VCO.

This mixer thus outputs a low-frequency signal which can then be analyzed by a processing module in order to assess the range and velocity of the target.

Generally speaking, it is found that leakage phenomena can mean that a portion of the power generated on the output of the transmit circuit is not actually transmitted. This may involve, for example, reflection due to the radome that physically protects the antenna or situations in which the antenna has imperfections or is covered in materials that reflect the radar waves. In this case, some of the power that is to be transmitted reaches the receive circuit directly and has a level that can be relatively high.

In particular, noise that is present in the transmitted signal may subsequently also be present in the output signal of the detection circuit at a high level because this signal is recombined with the signal from the VCO which has an almost identical frequency spectrum. It is therefore apparent that the existence of leaks reveals noise that is present in the transmitted signal.

Various solutions have already been proposed in order to reduce the effect of noise that is present in the transmitted signal.

Thus, a first solution involves inserting a phase shifter in the transmit circuit downstream from the VCO. It has been found that, by varying the phase shift introduced, it is possible to reduce the effect that noise in the transmitted signal has on the output signal. However, such a solution remains highly selective and does not have the same effect on the entire frequency spectrum. Also, and above all, it can be tricky or even impossible to determine the optimal phase shift insofar as this phase shift may depend on numerous parameters associated with the device and/or its external environment.

Another solution is that proposed in the document entitled “Ka-Band FMCW Radar Front-End With Adaptative Leakage Cancellation” (IEEE transactions on microwave theory and techniques, vol. 54, No. 12, December 2006, page 4041). This solution makes it possible to reduce or even cancel out the effect of noise in the transmitted signal by subtracting the filtered transmitted signal from the received signal. This system nevertheless remains very complex to implement and has the disadvantage of making the system insensitive to signals whose frequency is too close to the carrier wave of the transmitted signal. In addition, it does not make it possible to eliminate leakage in the useful band.

### SUMMARY OF THE INVENTION

It would be desirable to limit the effect of leakage and at the same time realize a system that would be easy to implement. It would also be useful if such a system were relatively insensitive to the structure of the component units of the radar, such as the antenna in particular, as well as to external factors, such as temperature in particular.

Thus, in order to achieve all or some of these objects, according to one embodiment, the device for transmitting/receiving frequency modulated radar waves may include:

A circuit for generating radar waves which comprises a voltage-controlled oscillator coupled to a circulator which is itself connected to a transmit/receive antenna;

A detection circuit comprising a first mixer fed by said circulator circuit and said voltage-controlled oscillator.

In this embodiment, the voltage-controlled oscillator comprises an input for injecting a signal generated by an additional circuit. The output signal of the voltage-controlled oscillator is fed to the input of this additional circuit which comprises a second mixer that is fed by two signals generated on the basis of the output signal of the voltage-controlled oscillator.

In another embodiment, the transmit circuit may include an amplifier connected between the voltage-controlled oscillator and the circulator in order to obtain the desired power level. The effect of leaks may be more or less critical, depending on this power level, and the attractiveness of the additional circuit may thus be even greater.

In one version of this architecture, the detection circuit may include a low-noise amplifier connected between the circulator and the first mixer. It is also possible for the corresponding amplification to take place within the actual mixer.

In one particular embodiment, the two signals that feed the second mixer of the additional circuit correspond to the output signal of the voltage-controlled oscillator.

In another embodiment, the additional circuit may comprise a phase shift stage that acts on the second signal that is fed to the second mixer so that the latter acts on the two phase-shifted signals.

In one particular embodiment, this phase shift angle may be adjustable.

In one particular embodiment, the additional circuit may comprise a low-pass filter stage located on the output of the second mixer in order to reinject a signal that is representative of the low-frequency amplitude noise into the VCO.

### BRIEF DESCRIPTION OF THE DRAWINGS

Certain aspects and advantages will be more readily understood from the descriptions of the following embodiments, given merely by way of example and making reference to the accompanying drawings in which:

FIG. 1 is a schematic circuit diagram showing the various components that constitute a radar wave transmit/receive device according to one particular embodiment;

FIG. 2 is a schematic circuit diagram showing a voltage-controlled oscillator that can be included in the circuit diagram in FIG. 1; and

FIG. 3 is a schematic circuit diagram showing an alternative embodiment of a voltage-controlled oscillator that can be included in the circuit diagram in FIG. 1.

### DETAILED DESCRIPTION

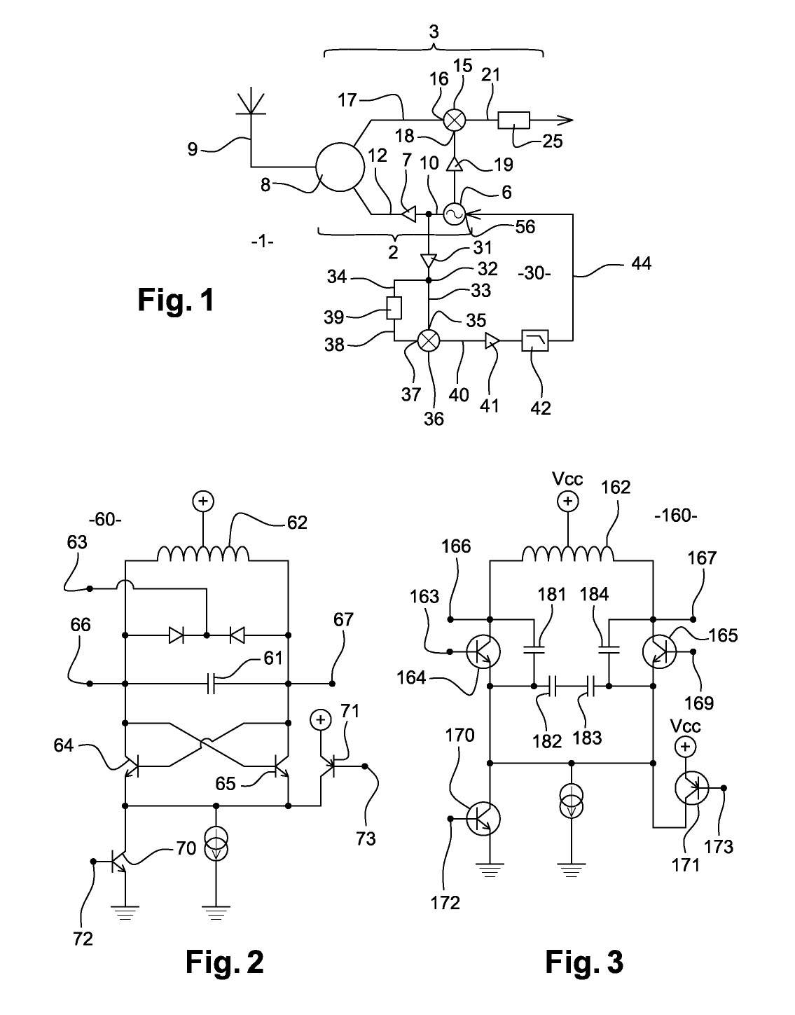

As shown in FIG. 1, radar wave transmit/receive device 1 comprises a transmit circuit 2 and a receive circuit 3. Circuit 2 mainly comprises a voltage-controlled oscillator 6 (VCO), a power amplifier 7 and a circulator 8. The design of VCO 6 may vary greatly as long as it makes it possible to generate variable-frequency signal 10. More precisely, for FMCW radar applications, the frequency of the output signal of the VCO varies linearly in time between two given frequency limits.

This output signal 10 feeds a power amplifier 7 of traditional design. This power amplifier 7 outputs a signal 12 to a circulator 8 which is connected to transmit/receive antenna 9 in a conventional manner. Similarly, circulator 8 is part of receive circuit 3 which comprises a mixer 15. This mixer 15 therefore has a first input 16 which corresponds to signal 17 received by the antenna. Mixer 15 may include an amplification function but it is also possible for amplification, if necessary, to be provided by a specific component, preferably a low-noise component, which is connected between circulator 8 and mixer 15. The other input 18 of mixer 15 is connected to VCO 6 via power amplifier 19. In the same way, this amplification can be provided by a mixer stage 15. This mixer 15 thus multiplies the two signals connected to these two inputs 16, 18 so that signal 21 generated by mixer 15 has, in the lower part of its frequency spectrum, components in a frequency band that corresponds to the difference between the frequency of the signal of VCO 6, i.e. the frequency of the transmitted signal, and the frequency of received signal 17. This frequency difference is directly related to the range and velocity of the target that reflected the transmitted waves and to the modulation rate. It is therefore the desired signal that can then be analyzed by an appropriate signal processing module 25 which there is no need to describe in detail here.

As shown in FIG. 1, device 1 also comprises an additional circuit 30 designed to reduce the amplitude noise generated by VCO 6. More precisely, in the embodiment shown in FIG. 1, the additional circuit comprises an amplifier 31 which acts, in particular, as an antenna matching transformer. This makes it possible to generate a signal 32 which corresponds to output signal 10 of VCO 6 that can be duplicated in order to form two channels 33, 34. One of these signals 33 feeds a first input 35 of second mixer 36. The other input 37 of mixer 36 is fed by a second signal 38 which, in the embodiment shown, is generated on the basis of output signal 10 of VCO 6 by using a phase shift stage 39 to apply a given phase shift. Adjusting the phase shift produced by phase shifter 39 makes it possible to reduce the DC offset voltage which can interfere with correct operation of amplifier 41. Nevertheless, good results, in terms of reducing the noise of the VCO, are obtained even without this phase shifter or by using other means that make it possible to reduce or even cancel this DC offset voltage.

Output signal 40 of mixer 36 has a low-frequency component which is directly related to the amplitude noise of VCO 6. This signal 40 feeds an amplifier 41 and a low-pass filter 42 whose cutoff frequency is determined depending on the spectrum of the amplitude noise that one wishes to eliminate and is typically around several tens to several hundreds of Hertz.

After being thus filtered, signal 44 is then injected into VCO 6 so as to form a feedback loop for the signal for the amplitude noise generated by the VCO. Signal 44 is phase shifted by 180° in order to subtract it from the internal noise in the VCO. This phase shift can be obtained by using any appropriate circuit or even by reversing the connections between the output of low-pass filter 42 or mixer 36 and VCO 6 if they are mounted in differential mode.

The gain G_{B} of this feedback loop is made up of the gain G₁ of amplifier 31, the gain G₂ of mixer 36, taken between the fundamental frequency of the VCO and the low-frequency, and the gain G₃ of amplifier 41 combined with low-pass filter 42. Gain G_{A}, which corresponds to the ratio between the amplitude noise generated by the VCO and injected characteristic signal 44, has a value which depends on the design of the VCO, the components integrated in it and other external factors. In order to obtain amplitude noise that is as low as possible, the open-loop gain, which is the product of gain G_{A} and gain G_{B} of the feedback loop, should be very much greater than or very much less than 1. Thus, choosing a very high feedback-loop gain G_{B} makes it possible to avoid the complex determination operation that is required in the case of open-loop gain G_{A}.

Obviously and in practice, mixer 36, the various amplifier stages 31, 41 and low-pass filter 42 can be realized by separate components or even components that realize several of these forms or even by a single overall component,

From a practical point of view, VCO 6 is designed with one input 56 that makes it possible to reinject a signal in order to cancel its amplitude noise. Various options are possible, depending on the type of VCO schematic chosen.

One particular example is shown in FIG. 2 which corresponds to an LC coupled oscillator. Such a VCO 60 classically comprises a resonant circuit that includes a capacitor 61 and an inductor 62 which form a resonant circuit and a control input 63 that makes it possible to modify the oscillation frequency as well as two transistors 64, 65 that operate in switched mode. Terminals 66, 67 output the output signal of the VCO at the desired frequency differentially.

In the embodiment shown in FIG. 2, VCO 60 also comprises two additional transistors 70, 71 via the bases 72, 73 whereof the signal obtained from the feedback loop is applied. These two transistors 70, 71 are designed to advantageously receive a differential signal but it is also possible, through adaptations which are within the capabilities of those skilled in the art, to provide a single input for injecting the feedback signal.

Obviously, other VCO structures can be envisaged, for example that shown in FIG. 3 which is a Colpitts oscillator. Such a VCO 160 classically comprises a resonant circuit that includes a number of capacitors 181, 182, 183, 184 and an inductor 162 and two control inputs 163, 164 comprising the bases of two transistors 164, 165 that make it possible to modify the oscillation frequency. Terminals 166, 167 output the output signal of the VCO at the desired frequency differentially.

In the embodiment shown in FIG. 3, VCO 160 also comprises two additional transistors 170, 171 via the bases 172, 173 whereof the signal obtained from the feedback loop is applied. These two transistors 170, 171 are designed to receive a differential signal but it is also possible, through adaptations which are within the capabilities of those skilled in the art, to provide a single input for injecting the feedback signal.

Generally speaking, the feedback signal is injected in a location of the circuit of the VCO where the signal is not likely to combine with the noise of the carrier wave.

The Applicant has conducted tests which have enabled it to confirm that, contrary to received wisdom, voltage-controlled oscillators can be a source of non-negligible noise. Thus, by acting directly on the VCO in order to compensate the noise level in the signal generated by the VCO, the Applicant has obtained results that are satisfactory in terms of the level of the interfering signal that is observed when leaks occur in transmit circuit 2. Using additional circuit 30 to reduce the noise of the VCO has the advantage of making noise reduction possible without using the desired signal, i.e. the signal transmitted to the antenna.

While this detailed description has set forth some embodiments of the present invention, the appended claims cover other embodiments of the present invention which differ from the described embodiments according to various modifications and improvements. For example, other versions can be realized in the same spirit, taking into account, when determining each of the components, the constraints imposed by other systems that interact with the transmit/receive device, especially a Phase Locked Loop (PLL). Thus, those skilled in the art will classically ensure the stability of all the control loops that involve or interact with the loop for controlling the amplitude noise of the VCO as described above.

Having thus described at least one illustrative embodiment of the invention, various alterations, modifications, and improvements will readily occur to those skilled in the art. Such alterations, modifications, and improvements are intended to be within the spirit and scope of the invention. Accordingly, the foregoing description is by way of example only and is not intended as limiting. The invention is limited only as defined in the following claims and the equivalents thereto.

What is claimed is:

1. Device for transmitting/receiving frequency modulated type radar waves including:
a circuit for generating radar waves which comprises a voltage-controlled oscillator coupled to a circulator which is itself connected to a transmit/receive antenna;
a detection circuit comprising a first mixer suitable for being fed by said circulator and said voltage-controlled oscillator,
and wherein voltage-controlled oscillator comprises an input for injecting a signal generated by an additional circuit, said additional circuit being suitable to have its input fed by the output signal of voltage-controlled oscillator and comprising a second mixer suitable for being fed by two signals generated on the basis of the output signal of voltage-controlled oscillator.

2. Device as claimed in claim 1 wherein a power amplifier is connected between voltage-controlled oscillator and circulator.

3. Device as claimed in claim 1, wherein a low-noise amplifier is connected between circulator and first mixer.

4. Device as claimed in claim 1, wherein the first signal that feeds second mixer corresponds to the output signal of voltage-controlled oscillator.

5. Device as claimed in claim 1, wherein the second signal that feeds second mixercorresponds to the output signal of voltage-controlled oscillator.

6. Device as claimed in claim 1 wherein additional circuit comprises a phase shift stage suitable for acting on the second signal that feeds second mixer.

7. Device as claimed in claim 6 wherein the phase shift angle of phase shift stage is adjustable.

8. Device as claimed in claim 1, wherein the additional circuit comprises a low-pass filter stage on the output of second mixer.
